(19) United States
(12) Patent Application Publication
(10) Pub. No.: US 2025/0211576 A1
(43) Pub. Date: Jun. 26, 2025

(54) END-TO-END MAC-SECURITY PATH SETUP IN LEVEL 3 VIRTUAL PRIVATE NETWORKS

(71) Applicant: Telefonaktiebolaget LM Ericsson (publ), Stockholm (SE)

(72) Inventor: Xu WU, Beijing (CN)

(21) Appl. No.: 18/848,343

(22) PCT Filed: Apr. 12, 2022
(86) PCT No.: PCT/CN2022/086275

§ 371 Date: Sep. 18, 2024

(51) Int. Cl. H04L 9/40

(52) U.S. Cl. CPC H04L 63/0272

(57) ABSTRACT

A method performed in a label-switched network is provided, and includes: to agree on a set of Media Access Control security, MACsec, policies for each of a plurality of interconnected node pairs of the network; to agree on an association between MACsec policies and MACsec labels for each interconnected node pair, and to establish a set of user information rules and associating each user information rule with a MACsec policy in at least one of the PE nodes. Corresponding methods for configuring PE and P nodes, PE and P node entities, a label-switched network, an improved MACsec packet and computer programs and computer program products are also provided.

### TECHNICAL FIELD

The present disclosure relates to the field of secure communication networks. In particular, the present disclosure relates to how to improve path-setup granularity in a Layer 3 Virtual Private Network (L3VPN) secured using Medium Access Control security (MACsec).

### BACKGROUND

Medium Access Control security (MACsec) is a hop-by-hop link layer security protocol suitable for the Ethernet. MACsec provides data encryption, replay protection, and also anti-tampering. Standards for authenticating and encrypting packets between two MACsec-capable devices are defined in IEEE 802.1AE, while MACsec peer-discovery and key-negotiation in MACsec are provided by the MACsec Key Agreement (MKA) protocol as defined in IEEE 802.1X.

In Virtual Private Networks (VPNs) using a label-switched backbone (implementing e.g. Multi-Protocol Label Switching, MPLS), MACsec can secure the traffic path crossing the various nodes, such as consumer edge (CE) devices, provider edge (PE) nodes/routers and provider (P) nodes/routers. In Level 2 VPNs (L2VPNs), MACsec generally secures the path between CE and PE nodes, or (for end-to-end connections) between two CE and CE devices. Generally, a peer is identified by its MAC address and Virtual LAN (VLAN)/port.

Due to customer demand, MACsec engine vendors have decided to provide capability of flow classification associated with specific MACsec policies. A network operator may want to set up a MACsec secure path and apply a specific MACsec policy based on e.g. a specific CE peer (as identified by the CE MAC address), VPN (associated with a User-to-Network interface, UNI), or e.g. some given traffic flow (as defined by Level 2/3/4 header). For example, a customer would want to encrypt only management packets and synchronization (e.g., using the Precision Time Protocol, PTP), and not secure e.g. user service packets, or e.g. only encrypt specific VPN traffic from one or more VIP users. Such MACsec functionality often requires paying for one or more licenses, and introduces additional latency in packet forwarding. It may further be reasonable to have different security strategies for different traffic, e.g. by taking into account also traffic importance levels and network link security levels. To implement such specific security policies applied to different user traffic, user side information is essentially required.

However, in a Level 3 VPN (L3VPN), such user side information is missing or inaccessible on the backbone side. For example, the Level 2 MAC address of a CE device and the UNI number will be missing, and the L3/4 packet header will be inaccessible to a P node. Compared with L2VPNs, existing MACsec solutions in L3VPNs cannot provide the same fine-grained MACsec path setup possibilities.

### SUMMARY

To improve upon the situation described above, the present disclosure provides an improved method performed in a provider edge (PE) node of a label-switched network, an improved method performed in a provider (P) node of the label-switched network, an improved method performed in the label-switched network, an improved PE node entity, and improved P node entity, an improved label-switched network, an improved MACsec packet, and improved computer programs and computer program products as defined in the accompanying independent claims. Various alternative embodiments of the above methods, entities, network, computer programs and computer program products are defined in the accompanying dependent claims.

According to a first aspect of the present disclosure, a method performed in a provider edge (PE) node (entity, such as e.g. a router) of a label-switched network is provided. The method includes agreeing on a set of Media Access Control security (MACsec) policies with an adjacent provider (P) node of the network. The method includes agreeing on an association of MACsec labels and MACsec policies with the adjacent P node. The method further includes obtaining a set of user information rules, wherein each user information rule is associated with a MACsec policy.

Depending on what protocol that are used to distribute the MACsec labels and their associations with MACsec policies in the network, agreeing on the association between MACsec labels and MACsec policies may include either the PE receiving such an association from the adjacent P node, or the PE node allocating a MACsec label for each MACsec policy and then sending such an association to the adjacent P node. For example, if the PE node is an ingress PE node, and if e.g. the Label Distribution Protocol (LDP), the Resource Reservation Protocol (RSVP), or RSVP with Traffic Engineering (RSVP-TE), is used for distributing the MACsec labels, the PE node may e.g. receive the association of MACsec labels and MACsec policies from an adjacent (P) node in the network. If instead using Segment Routing for MACsec label distribution, the association between MACsec labels and MACsec policies may instead be distributed to the adjacent (P) node from the PE node in which the method of the first aspect is performed. It is envisaged that the allocation of MACsec labels and association with MACsec policies may be implemented using already available MPLS protocols such as e.g. LDP, RSVP and Segment routing.

Likewise, the PE node may obtain the set of user information rules from one or more other nodes in the network, including the associations between user information rules and MACsec policies. In other situations, it may be the PE node that is responsible for defining the set of user information rules, and to associate each user information rule with a MACsec policy. In particular, the important thing is that a PE node (such as e.g. an ingress PE node) which receives an incoming user packet knows (based on user side information extractable from the incoming user packet) which MACsec policy to use when sending the packet to an adjacent P node (or perhaps even to an adjacent PE node), and which MACsec label to attach to the packet before sending it further towards the egress PE node, such that the end-result is that all nodes in the network uses a same particular MACsec policy (number). Thus, in some embodiments, the method further includes the PE node defining the set of user information rules, and associating each user information rule with a MACsec policy.

Herein, the term “provider (P) node” (when used in a label-switched network) may also be referred to as a “label switch router” (LSR) or “transit router”. The term “provider edge (PE) node” may similarly be referred to as a “label edge router” (LER), or even as an “edge LSR”. The term “MACsec” may be defined as in IEEE 802.1AE. The term “label-switched network” may e.g. refer to a network configured to provide so-called Multi-Protocol Label Switching (MPLS), or e.g. any type of network where network addresses (which normally identify endpoints only) are complemented by labels which identify established paths between the endpoints in order to avoid having to perform address lookup at each node. A node within the label-switched network is usually a router. However, switches exist which also have Level 3/label-switching functionality, and in some embodiments a node within the label-switched network may also be such a switch.

In some embodiments of the method, the method may further include receiving a user packet from a customer edge (CE) device (such as a router, switch, terminal, or any other equipment the user wants to connect to the network). The method may include extracting user side information from the user packet, and matching the user side information against the set of user information rules to identify a particular MACsec policy using the association between user information rules and MACsec policies. The method may further include identifying a particular MACsec label associated with the particular MACsec policy using the association between MACsec labels and MACsec policies agreed on with the adjacent P node. The method may include modifying the user packet by inserting the particular MACsec label into the user packet. The method may further include applying the particular MACsec policy to the modified user packet and sending the modified user packet to the adjacent P node (or to an adjacent PE node) of the label-switched network. As described earlier, the association between MACsec labels and MACsec policies may have been received from the adjacent node to which the PE node sends the packet, or may have been defined at the PE node and then distributed to the adjacent node. The important thing is that the MACsec label is such that the adjacent node which receives the packet from the PE node knows which MACsec policy to use when further sending the packet to yet another node of the network.

In some embodiments of the method, modifying the user packet may further include inserting, into the user packet, also a MACsec label identifier (MLI) which identifies the particular MACsec label.

According to a second aspect of the present disclosure, there is provided a method performed in a P node (entity, such as e.g. a router) of a label-switched network. The method includes agreeing on a set of MACsec policies with an adjacent P node or PE node of the network. The method includes agreeing on an association between MACsec labels and MACsec policies with the adjacent PE node or P node. The method further includes agreeing on a set of MACsec policies with another adjacent P node or PE node of the network, and agreeing on an association of MACsec labels and MACsec policies with this another PE node or P node. In this way, the P node can use the MACsec label of an incoming packet to know which MACsec policy it should apply when sending the packet further towards an egress PE node of the network. The P node can also know what MACsec label to insert/include in the outgoing packet such that the receiving node may also apply the same particular MACsec policy when sending the packet yet further towards the egress PE node, and so on and so forth.

In some embodiments of the method, the method may further include receiving and processing a packet from an adjacent PE node or P node of the label-switched network, wherein the packet includes a particular MACsec label. The method may further include identifying a particular MACsec policy associated with the particular MACsec label using the association between MACsec labels and MACsec policies agreed on with the adjacent PE node or P node. The method may include identifying a second particular MACsec label associated with the particular MACsec policy, using the association between MACsec labels and MACsec policies agreed on with this another adjacent PE node or P node of the network. The method may include inserting/including the second MACsec label in the packet (e.g. by replacing the particular MACsec label in the incoming packet, if necessary). The method may further include applying the particular MACsec policy to the packet and sending the packet to this another adjacent PE node or P node of the label-switched network.

In some embodiments of the method, the packet may further include a MACsec label identifier (MLI) identifying the particular MACsec label. The method may further include identifying the particular MACsec label in the processed packet using the MLI.

According to a third aspect of the present disclosure, a method performed in a label-switched network (such as an MPLS backbone of a service/network provider) is provided, wherein the network includes a set of interconnected nodes (e.g. routers, or e.g. switches having Level 3/label-switching capabilities) including at least a first PE node, a second PE node, and at least one P node provided in between the first and second PE nodes. The method includes agreeing on a set of MACsec policies for each interconnected node pair. The method further includes agreeing on an association between MACsec policies and MACsec labels for each interconnected node pair. The method also includes establishing a set of user information rules and associating each user information rule with a MACsec policy in at least one of the first and second PE nodes.

In some embodiments of the method, the method may further include, in one of the first and second PE nodes: receiving a user packet from a first CE device adjacent to the one of the first and second PE nodes; extracting user side information from the user packet, and matching the user side information against the set of user information rules to identify a particular MACsec policy using the association between user information rules and MACsec policies; identifying a particular MACsec label associated with the particular MACsec policy using the association between MACsec labels and MACsec policies agreed on with the at least one P node; modifying the user packet by inserting the particular MACsec label into the user packet, and applying the particular MACsec policy to the modified user packet and sending the modified user packet to the at least one P node. The method may further include, in the at least one P node: receiving and processing the packet from said one of the first and second PE nodes; identifying the particular MACsec policy associated with the particular MACsec label using the association between MACsec labels and MACsec policies agreed on with said one of the first and second PE nodes, identifying a second particular MACsec label associated with the particular MACsec label policy using the association between MACsec labels and MACsec policies agreed on with another P node of the network or said other one of the first and second PE nodes, inserting/including the second particular MACsec label into the packet (e.g. by updating the MACsec label present in the incoming packet to the at least one P node), and applying the particular MACsec policy to the packet and sending the packet to said another P node of the label-switched network or to said other one of the first and second PE nodes. The method may further include, in said other one of the first and second PE nodes: receiving and processing the packet from the at least one P node or from another P node of the label-switched network, and sending the packet to a second CE device adjacent to said other one of the first and second PE nodes. Here, when the other one of the first and second PE nodes is said to receive the packet from another P node of the network, it is implied that this packet has been processed and modified accordingly by one or more additional nodes than the at least one P node before arriving at the other one of the first and second PE nodes. As described above, this method allows a packet to be routed from an ingress PE node to an egress PE node using a same MACsec policy (number) at each hop.

In some embodiments of the method, the label-switched network may implement Multi-protocol Label Switching (MPLS). As used herein, the term MPLS is assumed to include also further developments of MPLS, such as e.g. Generalized Multi-Protocol Label Switching (GMPLS).

In some embodiments of the method, the method may be used to establish an end-to-end MACsec path between the first and second CE devices in a Level 3 Virtual Private Network (L3VPN).

According to a fourth aspect of the present disclosure, a PE node entity for a label-switched network is provided. The PE node entity (which may be e.g. a router) includes processing circuitry. The processing circuitry is configured to cause the PE node entity to: agree on a set of MACsec policies with an adjacent provider (P) node entity; to agree on an association of MACsec labels and MACsec policies with the adjacent P node entity; and to obtain a set of user information rules, wherein each user information rule is associated with a MACsec policy. As mentioned before, in other embodiments, the PE node entity may be further configured to, by itself, define the MACsec labels and associate each label with a MACsec policy (and to distribute this association between MACsec labels and MACsec policies to the adjacent (P, or PE) node entity of the label-switched network), or to e.g. receive such an association from the adjacent (P, or PE) node entity of the network.

The envisaged PE node entity is thus configured to perform the steps of the method according to the first aspect.

In some embodiments of the PE node entity, the PE node entity may be further configured to (or e.g. its processing circuitry may be further configured to cause the PE node entity to) perform any embodiment of the method according to the first aspect as disclosed herein.

According to a fifth aspect of the present disclosure, a P node entity for a label-switched network is provided. The P node entity (which may be e.g. a router) includes processing circuitry. The processing circuitry is configured to cause the P node entity to: agree on a set of MACsec policies with an adjacent P node entity or provider (PE) node entity of the network; to agree on an association between MACsec labels and MACsec policies with the adjacent PE node entity or P node entity of the label-switched network, to agree on a set of MACsec policies with another adjacent PE node entity or P node entity of the network, and to agree on an association between MACsec labels and MACsec policies with this another adjacent PE node or P node of the label-switched network.

The envisaged P node entity is thus configured to perform the steps of the method according to the second aspect.

In some embodiments of the P node entity the P node entity may be further configured to (or e.g. its processing circuitry may be further configured to cause the P node entity to) perform any embodiment of the method according to the second aspect as disclosed herein.

According to a sixth aspect of the present disclosure, a label-switched network is provided. The network includes a set/plurality of interconnected nodes, including a first PE node entity, a second PE node entity, and at least one P node entity (connected somewhere in between the first and second PE nodes). The network (i.e. the set/plurality of interconnected nodes) is configured to: agree on/establish a set of MACsec policies for each interconnected node pair; to agree on/establish an association between MACsec policies and MACsec labels for each interconnected node pair, and to establish a set of user information rules and to associate each user information rule with a MACsec policy in at least one of the first and second PE nodes.

The label-switched network is thus configured to perform the method according to the third aspect of the present disclosure.

In some embodiments of the label-switched network, the network is further configured to perform any embodiment of the method according to the third aspect as disclosed herein. In some embodiments, the label-switched network may be configured to implement MPLS or other developments thereof, such as e.g. GMPLS.

According to a seventh aspect of the present disclosure, there is provided a computer program for configuring a PE node entity of a label-switched network. The computer program includes computer code which, when run on processing circuitry of the PE node entity, causes the PE node entity to: agree on a set of MACsec policies with an adjacent provider (P) node entity of the network; to agree on an association of MACsec labels and MACsec policies with the adjacent P node entity, and to define a set of user information rules, wherein each user information rule is associated with a MACsec policy. In some embodiments, the computer program may be configured to cause the PE node entity to allocate the MACsec labels and to associate each MACsec label with a MACsec policy, and to then distribute this association to the adjacent P node entity.

The envisaged computer program is thus configured to cause the PE node entity on which it is being run to perform the steps of the method according to the first aspect.

In some embodiments of the computer program, the computer code is further such that it, when run on the processing circuitry of the PE node entity, causes (i.e. the computer program is configured to cause) the PE node to perform any embodiment of the method according to the first aspect as disclosed herein.

According to an eight aspect of the present disclosure, there is provided a computer program for configuring a P node entity of a label-switched network. The computer program includes computer code which, when run on processing circuitry of a P node entity, causes the P node entity to: agree on a set of MACsec policies with an adjacent P node entity or provider edge (PE) node entity of the network; to agree on an association between MACsec labels and MACsec policies with the adjacent PE node entity or P node entity, to agree on a set of MACsec policies with another adjacent P node entity or PE node entity of the network, and to agree on an association between MACsec labels and MACsec policies with this another adjacent PE node entity or P node entity of the label-switched network.

The envisaged computer program is thus configured to cause the P node entity on which it is being run to perform the steps of the method according to the second aspect.

In some embodiments of the computer program, the computer code is further such that it, when run on the processing circuitry of the P node entity, causes (i.e. the computer program is configured to cause) the P node to perform any embodiment of the method according to the second aspect as disclosed herein.

According to ninth and tenth aspects of the present disclosure, there is also provided computer program products which comprises computer programs according to the seventh and eight aspect of the present disclosure, respectively. As envisaged herein, a computer program product includes a computer-readable storage medium on which its computer program is stored. As used herein, the computer-readable storage medium may e.g. be non-transitory, and be provided as e.g. a hard disk drive (HDD), solid state drive (SDD), USB flash drive, SD card, CD/DVD, and/or as any other storage medium capable of non-transitory storage of data. In other embodiments, the computer-readable storage medium may be transitory and e.g. correspond to a signal (electrical, optical, mechanical, or similar) present on e.g. a communication link, wire, or similar.

According to an eleventh aspect of the present disclosure, there is provided a MACsec packet. The MACsec packet is extended (vis-à-vis as defined in e.g. IEEE 802.1AE) by including therein a MACsec label. The MACsec label is for associating the MACsec packet with a MACsec policy, as described herein.

The envisaged methods, entities, network, MACsec packet, computer program and computer program product improve upon currently available solutions in that they provide a more flexible way of setting up an end-to-end CE MACsec path, and in that they allow to apply unified MACsec policy based on fine-grained user information on the backbone side in an L3VPN. This is obtained by introducing the new concept of a “MACsec label” that represents the user information of the UNI side and which is associated with MACsec policy on all PE/P nodes, and may be particularly useful in MPLS L3VPN situation where a customer would like to deploy an end-to-end MACsec secured path based on specific user information. The proposed solution provides the capability of end-to-end MACsec policy selection based on user information in the L3VPN. Phrased differently, the envisaged solutions allow to apply MACsec policy in a more granular fashion compared to currently available solutions, and based on fine-grained user information. This also makes the MACsec deployment more flexible and provides a broader usage in L3VPNs. In addition, the MACsec label capability does not have to be imposed on existing node devices. That is, devices with the proposed MACsec label capability may coexist together with legacy devices which lack such capability, which in turn ensures high compatibility in existing networks. The proposed solution is also agnostic with regards to specific routing protocols, such as e.g. MPLS signaling protocols. The proposed solution also does not bring about much change on existing (router) node implementations, as it offers to mainly leverage existing technologies such as MPLS label stack handling, control-plane MPLS routing protocols (LDP, RSVP, Segment Routing, etc.) as well as MACsec session negotiation protocols such as MACsec Key Agreement (MKA).

Other objects and advantages of the present disclosure will be apparent from the following detailed description, the drawings and the claims. Within the scope of the present disclosure, it is envisaged that all features and advantages described with reference to e.g. the method of the first aspect are relevant for, apply to, and may be used in combination with also the methods of the second and third aspects, the entities of the fourth, fifth and sixth aspects, the computer programs of the seventh and eight aspects, the computer program products of the ninth and tenth aspects, and the MACsec packet of the eleventh aspect, and vice versa.

### BRIEF DESCRIPTION OF THE DRAWINGS

Exemplifying embodiments will be described below with reference to the accompanying drawings, in which:

FIG. 1A schematically illustrates a VPN;

FIG. 1B schematically illustrates the use of MACsec in a L2VPN;

FIG. 1C schematically illustrates the use of MACsec in an MPLS backbone;

FIG. 2A schematically illustrates a sharing of MACsec labels and their associations with MACsec policies as envisaged in the present disclosure;

FIG. 2B schematically illustrates embodiments of methods performed in PE and P nodes of a label-switched network according to the present disclosure;

FIG. 2C schematically illustrates further embodiments of methods performed in PE and P nodes of a label-switched network according to the present disclosure;

FIG. 2D schematically illustrates packet encapsulation as envisaged in the present disclosure;

FIGS. 3A and 3B schematically illustrate various embodiments of PE node entities according to the present disclosure;

FIGS. 4A and 4B schematically illustrate various embodiments of P node entities according to the present disclosure, and

FIG. 5 schematically illustrates various embodiments of computer program products according to the present disclosure.

In the drawings, like reference numerals will be used for like elements unless stated otherwise. Entities of a same type will be referred to using only a numerical value, e.g. “123”, and a specific element of such a same type will be referred to using the numerical value plus a letter, e.g. “123a”. Unless explicitly stated to the contrary, the drawings show only such elements that are necessary to illustrate the example embodiments, while other elements, in the interest of clarity, may be omitted or merely suggested.

### DETAILED DESCRIPTION

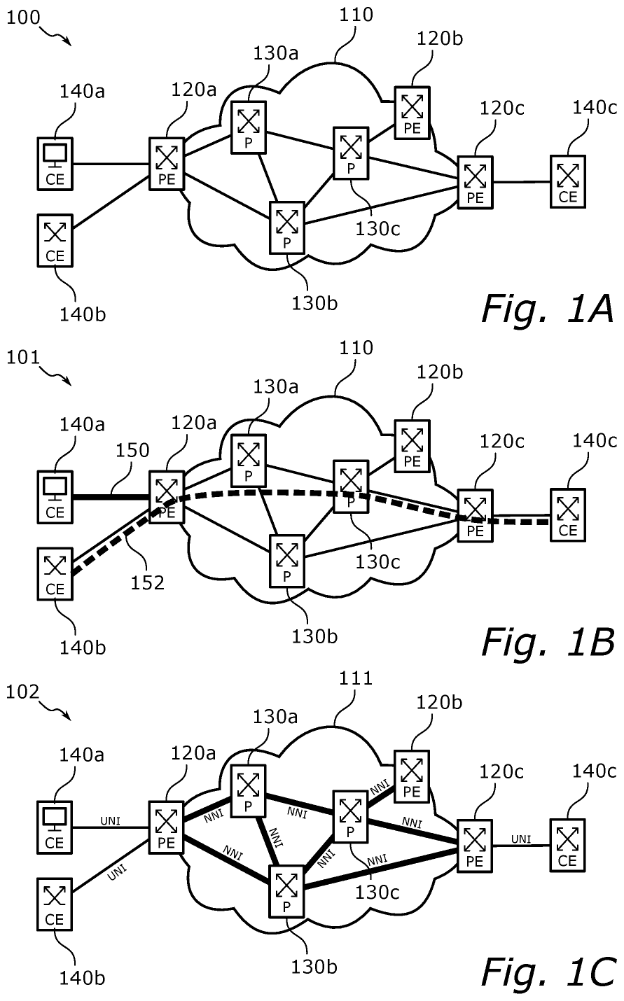

FIG. 1A schematically illustrates a VPN 100 as provided by a backbone 110 operated by a network/service provider.

The backbone 110 includes a plurality of interconnected nodes, including PE nodes 120a-c as well as P nodes 130a-c connected in between the PE nodes 120a-d. Various CE devices connects to the backbone 110 at the PE nodes. In the particular example illustrated in FIG. 1A, a CE terminal 140a and a CE switch 140b both connects to the PE node 120a, while a CE router 140c connects to the PE node 120c.

FIG. 1B schematically illustrates a L2VPN 101. In this network, MACsec is used to secure paths between CE devices and PE nodes (such as the path 150 between CE device 140a and PE node 120a), and between two CE devices to create a secure end-to-end CE path (such as the path 152 between CE devices 140b and 140c). As mentioned earlier herein, each peer in such a setup is generally identified by its MAC address and VLAN/port.

As also described earlier herein, in a L3VPN such as schematically illustrated in FIG. 1C, an end-to-end CE path cannot be set up because the original L2 header (MAC address) in a packet is stripped and rewritten on the PE/P nodes. To provide a secure path between an ingress PE node (such as the PE node 120a) and an egress PE node (such as the PE node 120c), a currently available solution is to deploy per-hop MACsec in an MPLS backbone 111. Here, MACsec is enabled on NNIs between PE/P nodes 120a-c and 130a-c (as indicated by the bolder lines connecting these nodes), and all traffic traversing the NNIs are protected in a same fashion regardless of which CE device the traffic belongs to. In packet forwarding with MACsec processing, extra latency will be introduced due to the additional encryption processing, and extra bandwidth will be consumed due to the lengthening of a packet caused by insertion of the MACsec header.

As described earlier herein, different traffic types may have different security level requests, and a customer would therefore often like to identify and secure specific packet flows using different security policies instead of treating all traffic equally. Examples of traffic having different security level requests include e.g. confidential service traffic, normal service traffic, Management and Operation (OAM) traffic, and so on. Also, fronthaul traffic and 5G ultra reliable low latency communication (URLLC) applications may be extra sensitive to forwarding-latency, and filtering of such traffic to bypass MACsec may be necessary. Applying MACsec to only a part of the traffic “on-demand” may be beneficial to bandwidth-saving, and network management traffic may for example have higher security level than normal service data, and so on and so forth. As the user side information (such as L2 MAC address and/or UNI number) are missing in the L3VPN and as e.g. the L3/L4 packet header is inaccessible on e.g. P nodes, existing solutions do not offer fine-grained MACsec path setup in L3VPNs as are available in L2VPNs.

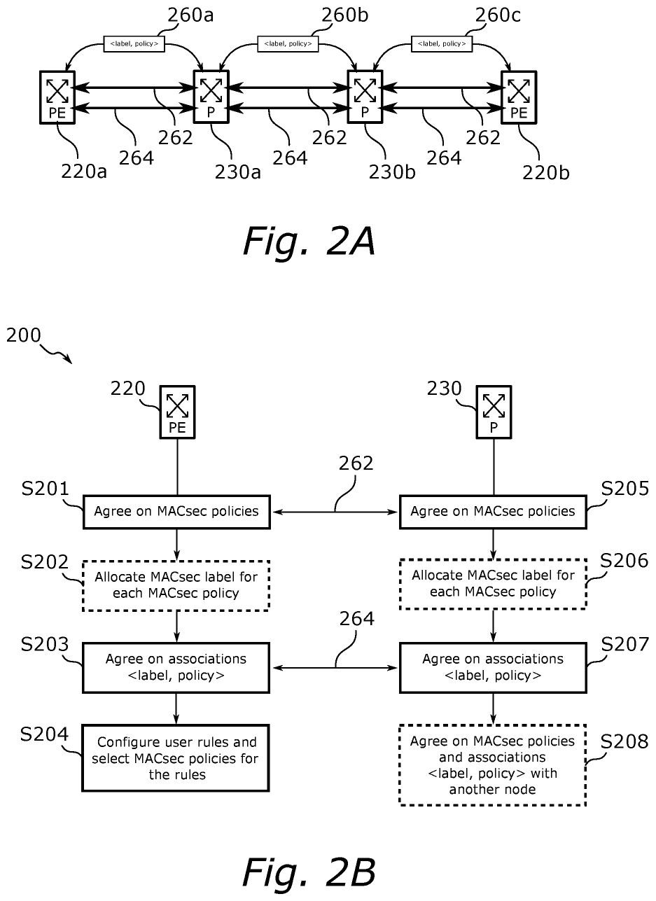

Exemplifying embodiments illustrating how the present disclosure improves upon this situation will now be explained in more detail with reference also to FIGS. 2A-D, 3A-B, 4A-B and 5 of the accompanying drawings, illustrating various methods, entities, MACsec packets, computer programs and computer program products according to the present disclosure. The drawings show only certain embodiments of the present disclosure. The invention of the present disclosure may, however, be embodied in many different forms and should not be construed as limited to the embodiments set forth herein; rather, these embodiments are provided for thoroughness and completeness, and fully convey the scope of the present disclosure to the skilled person.

The present disclosure envisages a solution which flexibly allows to set up end-to-end MACsec paths and apply unified MACsec policy based on fine-grained user information on the backbone side of an L3VPN. This is achieved by introducing a new concept of a “MACsec label” in the MACsec packet (datagram), which is introduced to represent user information (including e.g. MAC address of CE devices, VLAN/port, VPN-ID, traffic flow identifiers, etc.), and to associate this label with MACsec policy (e.g. cipher suite, replay/no replay, confidentiality offset, etc.). Such a MACsec label is envisaged as being any label value in regular MPLS label space, and may be a global resource shared between all PE/P nodes of the MPLS backbone, such that each MACsec label is associated with a specific MACsec policy.

The MACsec policies may be defined on the PE/P nodes and aligned using the existing MKA protocol, such that each interconnected node pair agree upon a set of available MACsec policies (where each MACsec policy is assigned a particular policy number/label). The MACsec labels may be agreed upon (i.e. allocated and distributed) by existing MPLS protocols such as LDP, RSVP(−TE), or e.g. Segment Routing, for all node pairs. These protocols may also be used to distribute the associations of MACsec labels and MACsec policies among the PE/P nodes. Phrased differently, each interconnected node pair may agree on how to label packets send therebetween such that the correct MACsec policy is selected when further transferring the packet from one of the members of the node pair to other nodes in the network.

FIG. 2A schematically illustrates how the envisaged MACsec labels, and their associations 260a-c with certain MACsec policies (<label, policy>) are distributed and shared among the PE/P nodes 220a-b and 230a-b. Between each PE/P, P/P and P/PE node pair, MKA 262 is used to define a set of MACsec policies, while MPLS protocols 264 such as e.g. LDP/RSVP (−TE)/Segment Routing are used to distribute allocated MACsec labels and their associations 260a-c with MACsec policies in each of the node pairs 220a and 230a, 230a and 230b, and 230b and 220b. As mentioned earlier herein, depending on what protocols that are used to distribute the MACsec labels and their associations with MACsec policies, the distribution may proceed either from an egress PE node (such as e.g. the PE node 220b) to an ingress PE node (such as e.g. the PE node 220a), or from the ingress PE node to the egress PE node. In the first case, direction of traffic (packet) flow can therefore be opposite to that of how the distribution of MACsec labels and their associations with MACsec policies flow.

FIG. 2B schematically illustrates an envisaged interaction between PE and P nodes in more detail. In a step S201 performed in the PE node 220, and in a step S205 performed in the P node 230, a set of MACsec policies are agreed upon between the pair consisting of the PE node 220 and the P node 230. The agreement/alignment is performed using the MKA protocol 262. If there are other interconnected pairs of nodes available, such agreement/alignment may be performed for each such pair. For example, referring back to FIG. 2A, a set/list of MACsec policies {p1, p2, p3, p4, . . . } may be defined and agreed upon for the pair consisting of the PE node 220a and the P node 230a as shown in FIG. 2A, and another set/list of MACsec policies {p1, p2, p3, p4, . . . } may be defined and agreed upon for the pair consisting of the P node 230a and the P node 230b, and similarly for the pair consisting of the P node 230b and the PE node 220b, etc. It should be noted that, as envisaged herein, the definition of MACsec policies on e.g. a PE/P node pair, a P/P node pair, and a P/PE node pair may be independent, and MACsec policy “p1” for e.g. the PE/P node pair 220a and 230a may therefore e.g. be different from the MACsec policy “p1” for the P/P node pair 230a and 230b, and so on. The same label/number “p1” is however used for all pairs, to indicate that the pair should use whatever specific MACsec policy definition that corresponds to this label/number.

If the PE node 220 is responsible for allocating MACsec labels and associate them with MACsec policies, this may be performed in a step S202. The result of such a step may e.g. be an association in form of a list of 2-tuples {{l1, p1}, {l2, p2}, {l3, p3}, . . . }, such that a label “l1” is associated with a policy “p1”, a label “l2” is associated with a policy “p2”, and so on. As envisaged herein, the labels “l1”, “l2”, “l3”, . . . , mean the same thing for each PE/P, P/P and P/PE node pair, but the exact meaning of the policy associated with each label for each node pair may be different. In a step S203, agreeing on the association between MACsec labels and MACsec policies may then include the PE node 220 sending such a list to the P node 230, for which P node 230 (in a step S207) the agreeing then includes receiving the list from the PE node 220. As also mentioned herein, the step S202 may be optional, if it is instead the P node 230 which is responsible for allocating and associating the MACsec labels. If this is the case, such allocating and associating is instead performed by the P node 230 in a step S206, and the agreeing step S207 then includes the P node 230 sending the list of MACsec labels and their associations with MACsec policies to the PE node 220, which PE node 220 (in a step S203) then receives the list from the P node 230. In essence, it is envisaged that the nodes 220 and 230 somehow agree upon how to label the packets such that the correct MACsec policy can be used everywhere in the network.

After at least one of the PE node 220 and the P node 230 have allocated and association the MACsec labels with MACsec policies (in optional step S202 or S206), agreeing (steps S203 and S207) on the associations may include using one of the MPLS protocols 264 (such as e.g. LDP/RSVP(−TE)/Segment Routing). The P node 230 receives and stores the association <label, policy>, and may in turn distribute it further to e.g. its own, other adjacent P or PE nodes.

As the P node 230 is often a transit-node, the envisaged method 200 may also include the P node 230 agreeing on a set of MACsec policies with another node in the network (such as another adjacent PE node or P node), and to also agree on an association between MACsec labels and MACsec policies with this another adjacent PE node or P node. This may be performed in an optional step S208. For example, if using FIG. 2A for reference, the P node 230a may agree on an association with the PE node 220a, and also agree on an association with the P node 230b, and so on and so forth, until all node pairs have agreed both on a set of MACsec policies and an association between MACsec labels and MACsec policies. As mentioned earlier herein, the individual pair-associations may be different, and the same policy number/label (as indicated by a MACsec label) may correspond to different MACsec policy specifications for two different node pairs. If the agreed-upon association(s) were to change, the agreeing steps S203 and S207 may be performed once again. For nodes which doesn't support the proposed MACsec label concept, such nodes may just transparently pass the association to nearby nodes without further action.

In a final step S204 performed by the PE node 220, a set of user information rules are defined, and each user information rule is associated with a respective MACsec policy. This has the effect that for each incoming CE traffic to the PE node 220, all traffic from a CE device matching a particular user information rule will be handled by a same MACsec policy number when propagated through the MPLS backbone. As a result of step S204, there may for example be defined as set of user information rules {r1, r2, r3, . . . }, and the PE node 220 may end up having an association in form of a list of 3-tuples such as {{r1, p1, l1}, {r2, p2, l2}, {r3, p3, l3}, . . . }., and each P node (such as P node 230) will have a corresponding association between MACsec labels and MACsec policies {{l1, p1}, {l2, p2}, {l3, p3}, . . . }. Thus, after having performed the necessary ones of steps S201-S204 (and likewise for other nodes of the MPLS backbone), at least all PE and P node pairs would each have a synchronized <label, policy> association table, while the PE node 220 in addition also has the association between user information rules and MACsec policies. As mentioned before, it may also be such that the PE node 220 instead receives the user rules and their associations with MACsec policies from another node (such as from another PE node, via the P node 230), in which case the step S204 may also be optional. In particular, the important thing is that the PE node 220 somehow obtains the user rules and their association with MACsec policies, such that the PE node 220 may determine (when receiving an incoming user packet from a CE device) what MACsec policy that is to be used when routing the packet across the MPLS backbone, and what MACsec label to attach to the outgoing packet, based on user side information obtainable from the incoming user packet.

It should be noted that FIG. 2B illustrates both a method as jointly performed in a label-switched network, but also individual sub-methods as performed by the individual entities 220 and 230. Phrased differently, when referring to “method 200” as performed by/in a label-switched network, it is meant to include all necessary steps performed by both entities 220 and 230. Likewise, when referring to “method 200” as performed by a specific one of the entities 220 and 230, it is meant only to include the necessary steps performed by this specific entity. For example, a “method 200” when referring to a PE node includes at least steps S201 and S203, and optionally one or both of steps S202 and S204. A “method 200” when referring to a P node includes at least steps S205 and S207 and, in some embodiments, also one or both of steps S206 and S208. For example, in one embodiment, the PE node 220 may perform steps S201 and S203. In another embodiment, PE node 220 may perform steps S201, S202 and S203 (if receiving the user rules etc.) from another node. In another embodiment, PE node 220 may perform steps S201, S203 and S204 (if receiving the associations of labels and policies from another node). In another embodiment, PE node 220 may perform all steps S201-S204. In one embodiment, P node 230 may perform steps S205 and S207 (if receiving the associations of labels and policies from another node). In another embodiment, P node 230 may perform steps S205, S206 and S207. In yet another embodiment, P node 230 may perform steps S205, S207 and S208. In yet another embodiment, P node 230 may perform all of steps S205-S208.

How an envisaged solution may be used to propagate a user packet in the MPLS backbone will now be described in more detail with reference also to FIG. 2C.

FIG. 2C schematically illustrates the various steps performed in the various nodes in one or more embodiments as envisaged herein, and how a packet flows between the various nodes. It is assumed that the node pairs 220a and 230a, 230a and 230b, and 230b and 220b, have each agreed upon a set of MACsec policies (using e.g. MKA 262), and also each agreed upon an association of MACsec labels and MACsec policies (using e.g. an available MPLS protocol 264). Thus, for each pair of interconnected nodes, there exists an agreed-upon association list {{l1, p1}, {l2, p2}, {l3, p3}, . . . }. It is further assumed that the PE node 220a has also defined and stored a set/list of user information rules, and created an association {{r1, p1, l1}, {r2, p2, l2}, {r3, p3, l3}, . . . } between user rules, MACsec policies and MACsec labels as described earlier herein.

First, a user packet 270 arrives at the PE node 220a, for example from a CE device (not shown) connected to the PE node 220a. The PE node 220a is in this case therefore an ingress PE node. In a step S210, the PE node 220a extracts user side information from the user packet 270 and matches this user side information against its list of user information rules. For example, it can be assumed (for illustrative purposes only) that the CE device from which the user packet 270 arrives is such that it matches user information rule “r2”. As envisaged herein, user information rules may e.g. be based on MAC address, VLAN+port, MAC address+VLAN+port, MAC address+VPN Label/ID, MAC address+IP address, etc., and each such rule may be associated with a particular MACsec policy, and such that each user packet whose user side information matches a specific rule can be assigned a correct MACsec label.

In a step S211, the PE node 220a checks its association list {{r1, p1, l1}, {r2, p2, 12}, {r3, p3, l3}, . . . } and finds that user information rule “r2” is associated with MACsec policy “p2” and MACsec label “l2”.

In a step S212, the PE node 220a therefore modifies the user packet 270 by inserting therein the MACsec label “l2”.

In a step S213, the PE node 220a then sends the modified (user) packet 271 to the adjacent P node 230a using the MACsec policy “p2” agreed upon with this P node 230a. The MACsec policy is used to encrypt the packet before sending it to P node 230a.

When the modified packet 271 arrives at the P node 230a, the P node 230a, in a step S214, the performs regular MACsec processing of the packet 270, including e.g. decryption of the packet 271.

After having decrypted the packet 271, in a step S215, the P node 230a identifies the MACsec label attached to the packet 271 by the PE node 230a and checks which MACsec policy number this MACsec label is associated with according to the association between MACsec labels and MACsec policies agreed on with the PE node 220a.

In a step S216, the P node 230a then checks which MACsec label that is associated with the MACsec policy number according to the association between MACsec labels and MACsec policies agreed on with P node 230b. The P node 230a modifies the packet 271 by replacing (if necessary) the previous MACsec label provided by the PE node 220a with this (potentially) new MACsec label, and then sends the modified packet 271 to the next P node 230b using the MACsec policy associated with the (potentially) new MACsec label (including e.g. encrypting the packet using this MACsec policy). Phrased differently, the envisaged solution is such that the MACsec labels may be modified at each hop (from one node to another), but in a way such that the nodes are able to all use a same MACsec policy number (such as e.g. “p1”) when transferring the user packet from an ingress PE node to an egress PE node. The envisaged solution therefore matches the design of traditional MPLS protocols such as e.g. LDP and RSVP.

After receiving the packet 271 from the P node 230a, the P node 230b may perform similar steps S217 as those performed e.g. by the P node 230a, and the modified packet 271 may be propagated accordingly towards a destination PE node 220b, which serves as an egress PE node in the example illustrated in FIG. 2C. As described above, this may include the P node 230b changing the MACsec label of the packet before sending it on further, in accordance with an agreed-on association of MACsec labels and MACsec policies with the receiving node. Although not illustrated in FIG. 2C, there may of course be one or more additional P nodes in between the P node 230b and the PE node 230b. In other embodiments, it is instead envisaged that the ingress PE node 220a is directly connected to the (egress) PE node 220b, in case no intermediate P nodes are used to route the user packet over the label-switched network.

The packet 271 is finally received by the PE node 220b. In a step S218, the PE node 220b performs regular MACsec processing of the packet 271, including decryption of the packet.

In a step S219, the PE node 220b identifies the MACsec label and strips the label from the packet. The packet can then be delivered (not shown) to a destination CE device connected to the PE node 220b.

In other embodiments, it is envisaged that the MACsec label is stripped from the packet already at the penultimate P node, i.e. the P node 230b if using the example illustrated in FIG. 2C. Such penultimate hop (MACsec label) popping (PHP) can allow the egress PE node 220b to focus on other things, and avoid having to spend resources on identifying and stripping/popping the MACsec label before being able to deliver the packet to the end CE device. The packet 270 once provided by the first CE to the PE node 220a is thus delivered to the end CE device, using a same MACsec policy number/label at each hop, where the exact MACsec policy specifics at each hop may be configured by e.g. the owner/operator of the label-switched network as desired.

As mentioned above for FIG. 2B, it should be noted that FIG. 2C illustrates both a method as jointly performed by multiple entities/nodes in a label-switched network, but also individual sub-methods as performed by the individual entities 220(a) and 230(a). Phrased differently, when referring to “method 201” as performed by/in a label-switched network, it is meant to include all steps performed by entities 220(a-b) and 230(a, and/or b). Likewise, when referring to “method 201” as performed by a specific one of the entities 220(a-b) and 230(a, and/or b), it is meant only to include the steps performed by this specific entity. For example, a “method 201” when referring to a PE node (such as PE node 220a) includes at least steps S210-S213. A “method 200” when referring to a P node (such as P node 230a, and/or P node 230b) includes at least steps S214-S216. Finally, a “method 201” when referring to e.g. the PE node 220b includes at least steps S218 and S219, at least in a situation wherein the MACsec label is not popped already by a penultimate node (such as P node 230b).

An illustration of how the packet encapsulation as envisaged herein is performed is illustrated in FIG. 2D.

A first CE device 240a sends the packet 270 to the ingress PE node 220a, with a wish for the packet 270 to be securely delivered to a second, end CE device 240b. The packet 270 is e.g. a normal L2 datagram which encapsulates an L3 packet. The packet 270 includes an L2 header 290, an L3 header 291, and a payload 292.

After being received and modified by the ingress PE node 220a, the modified packet 271 may e.g. include also a Label Switched Path (LSP) tunnel label 293, and the MACsec label 295 added by the PE node 220a. The PE node 220a may also add a MACsec label indicator (MLI) 294, which may be used to distinguish the MACsec label from other conventional MPLS labels. Such a special MLI label may e.g. be assigned from existing special-purpose label space of the MPLS protocol (as defined in e.g. RFC 7274). The MLI may be used by the receiving P node 230a to identify the MACsec label. The modified packet 271 may also include e.g. a VPN label 296, and is sent to the P node 230a using the MACsec policy indicated by the MACsec label 295. Using the MACsec policy may include encrypting part of the packet 270. It is envisaged that at least the L2 header 290 is not encrypted. Also, although not shown, it is also envisaged that there is provided a MACsec header (e.g. between the L2 header 290 and the LSP tunnel label 293), and that this MACsec header is not encrypted and is used to indicate to the receiving node which MACsec policy that was applied when encrypting the packet on the sending node, such that the receiving node may correctly decrypt the packet. The MACsec label may thus be encrypted by the sending node, as its purpose is to inform the receiving node which MACsec policy to apply when further sending the packet to yet another node of the network.

The P node 230a then receives the packet 271 from the PE node 220a and uses, after processing and decrypting the packet 271 (using the information available in the non-encrypted MACsec header), the MLI 294 to identify the MACsec label 295. The P node 230a then checks what MACsec policy the MACsec label 295 corresponds to (using the association agreed-upon with the P node 220a), and also checks what new MACsec label this MACsec policy corresponds to (using the association agreed-upon with the P node 220b). The P node 230a then modifies (if necessary) the packet 270 by updating the MACsec label to match this new MACsec label, and then sends the packet to the next P node 230b using the MACsec policy associated with the received MACsec label 295 received in the packet 271 from the PE nod 220a, for transmission across the link between the P node 230a and the P node 230b.

The next P node 230b similarly receives and processes the packet 271, and finally sends it to the egress PE node 220b using the MACsec policy for the link between the P node 230b and the PE node 220b which corresponds to the MACsec label 294 received from the P node 230a. In some embodiments, as described above, the penultimate P node 230b may choose to strip/pop the MACsec label 294 (and the MLI 295) from the packet before sending it to the egress PE node 220b.

The egress PE node 220b receives the packet 271 from the penultimate P node 230b, processes (e.g. decrypts it), and identifies and strips the MACsec label 294 and MLI 295 (if having not already been done by the P node 230b). The PE node 220b also strips the remaining elements related to the VPN tunneling, such as the LSP tunnel label 293 and the VPN label 296. As mentioned above, the MACsec label 295 may be updated/changed during each hop between nodes, while the corresponding MACsec policy number/label/name (as indicated by the MACsec labels) remains the same between all nodes. By so doing, only the MACsec policy number (or label/name) is visible to the customer. One or more of the other sections of the packets may also change when transferring the packet across the label-switched network. For example, one or both of the L2 header 290 and the LSP tunnel may be changed during one or more hops. Other sections of the packets, such as e.g. the VPN label 296, may e.g. remain unchanged. The VPN label 296 is for example allocated by the egress PE node 220b and distributed (e.g. via the P nodes 230a and 230b) to the ingress PE node 220a when setting up the VPN network.

In order for the MACsec policies, MACsec labels and the associations of both these to be carried using the signaling protocols such as LDP/RSPV/Segment Routing, or even Border Gateway Protocol (BGP), it is envisaged that a new type-length-variable (TLV) may be defined. For example, such a new TLV may include a MACsec label type (e.g. 0x0203 for LDP) followed by a length, and then followed by MACsec label value (e.g. values corresponding to “l1”, “l2”, “l3”, . . . , as used herein) and MACsec policy ID (e.g. values corresponding to “p1”, “p2”, “p3”, . . . , as used herein).

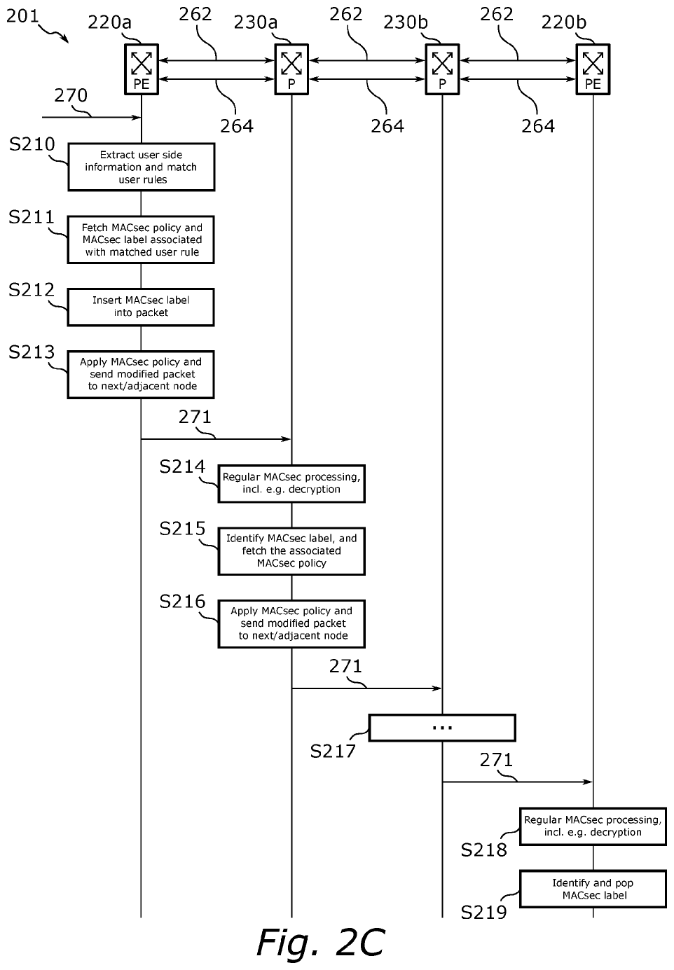

A PE node (e.g. a router) entity for a label-switched network will now be described in more detail with reference to FIGS. 3A and 3B.

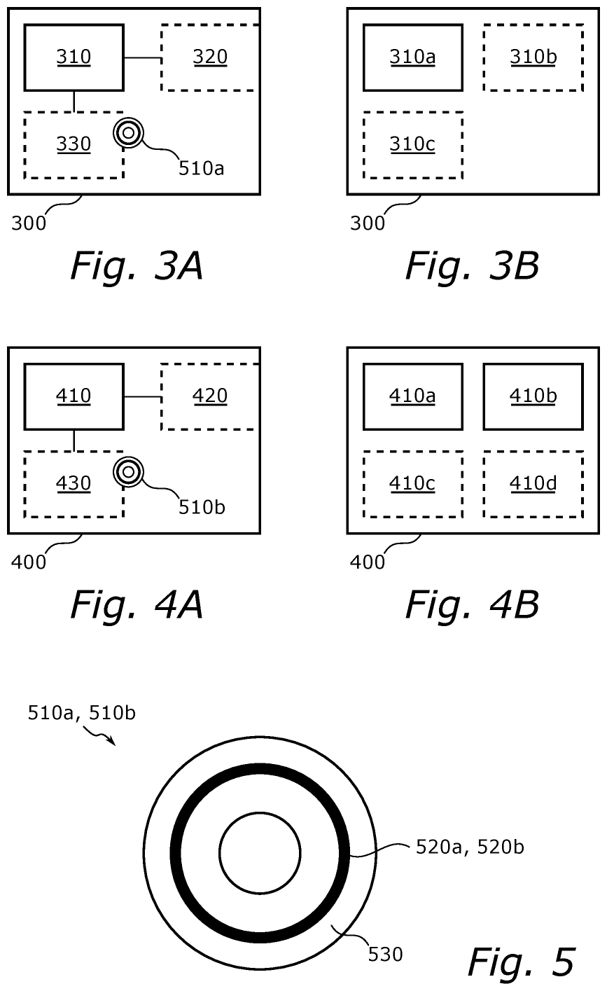

FIG. 3A schematically illustrates, in terms of a number of functional units, the components of an embodiment of a PE node entity 300 (or simply “PE node”) according to the present disclosure. The PE node entity 300 includes processing circuitry 310. The processing circuitry 310 is provided using any combination of one or more of a suitable central processing unit (CPU), multiprocessor, microcontroller, digital signal processor (DSP), etc., capable of executing software instructions stored in a computer program product 510a (see FIG. 5 and the description thereof), e.g. in form of a storage medium 330. The processing circuit 310 may further be provided as at least one application specific integrated circuit (ASIC), or field-programmable gate array (FPGA).

Particularly, the processing circuitry 310 is configured to cause the PE node entity 300 to perform a set of operations, or steps, such as one or more of steps S201-S204 as disclosed above e.g. when describing the method 200 illustrated in FIG. 2B. For example, the storage medium 330 may store a set of operations, and the processing circuitry 310 may be configured to retrieve the set of operations from the storage medium 330 to cause the PE node entity 300 to perform the set of operations. The set of operations may be provided as a set of executable instructions. Thus, the processing circuitry 310 is thereby arranged to execute methods as disclosed herein e.g. with reference to FIGS. 2B and/or 2C.

The storage medium 330 may also include persistent storage, which, for example, can be any single or combination of magnetic memory, optical memory, solid state memory or even remotely mounted memory.

The PE node entity 300 may further include a communications interface 320 for communications with other entities, functions, nodes, and devices of the network. For example, the communications interface 320 may allow the PE node entity 300 to communicate with e.g. a P node and/or a CE device. As such, the communication interface 320 may include one or more transmitters and receivers, including analogue and/or digital components.

The processing circuitry 310 controls the general operation of the PE node entity 300 e.g. by sending data and control signals to the communications interface 320 and the storage medium 330, by receiving data and reports from the communications interface 320, and by retrieving data and instructions from the storage medium 330. Other components, as well as their related functionality, of the PE node entity 300 are omitted in order not to obscure the concepts presented herein.

FIG. 3B schematically illustrates, in terms of a number of functional modules 310a, 310b and 310c, the components of a PE node entity 300 according to one embodiment of the present disclosure. The PE node entity 300 includes at least agree module 310a configured to perform step S201 of the method 200 described with reference to FIG. 2B, an agree module 310b configured to perform step S203, and an obtain/configure module 310c configured to perform step S204.

In general terms, each functional module 310a-c may be implemented in hardware or in software. Preferably, one or more or all functional modules 310a-c may be implemented by the processing circuitry 310, possibly in cooperation with the communications interface 320 and/or the storage medium 330. The processing circuitry 310 may thus be arranged to from the storage medium 330 fetch instructions as provided by a functional modules 310a-c, and to execute these instructions and thereby perform any steps of the method 200 performed by the PE node entity 300 as disclosed herein.

In some embodiments, the PE node entity 300 may further include additional functional modules (not shown) required to perform also e.g. step S202 of the method 200, and/or one or more of the steps S210-S213 of the method 201 described herein with reference to FIG. 2C. Such additional functional modules may e.g. include an allocate and association module for performing step S202, an extract module for performing step S210, a fetch module for performing step S211, an insert module for performing step S212, and an apply and send module for performing step S213 and to send the modified packet 271 to the nearby P node entity. The PE node entity 300 may also include e.g. a receive module for receiving the packet 270 from an adjacent CE device, or e.g. for receiving a packet from another node of the network (if the PE node entity 300 is e.g. used as an egress PE node entity).

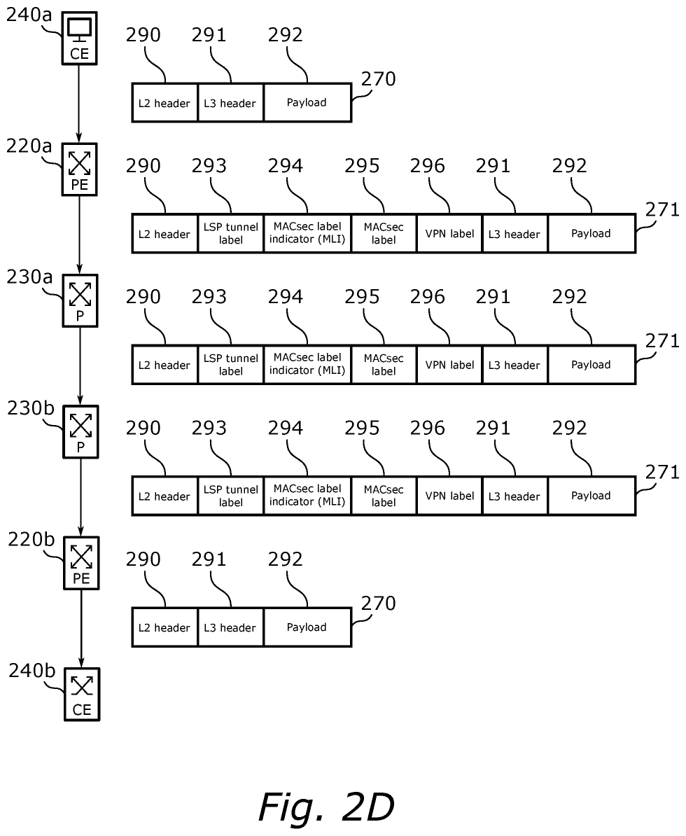

A P node (e.g. a router) entity for a label-switched network will now be described in more detail with reference to FIGS. 4A and 4B.

FIG. 4A schematically illustrates, in terms of a number of functional units, the components of an embodiment of a P node entity 400 (or simply “P node”) according to the present disclosure. The P node entity 400 includes processing circuitry 410. The processing circuitry 410 is provided using any combination of one or more of a suitable central processing unit (CPU), multiprocessor, microcontroller, digital signal processor (DSP), etc., capable of executing software instructions stored in a computer program product 510b (see FIG. 5 and the description thereof), e.g. in form of a storage medium 430. The processing circuit 410 may further be provided as at least one application specific integrated circuit (ASIC), or field-programmable gate array (FPGA).

Particularly, the processing circuitry 410 is configured to cause the P node entity 400 to perform a set of operations, or steps, as disclosed above e.g. when describing the method 200 illustrated in FIG. 2B and/or the method 201 illustrated in FIG. 2C. For example, the storage medium 430 may store a set of operations, and the processing circuitry 410 may be configured to retrieve the set of operations from the storage medium 430 to cause the P node entity 400 to perform the set of operations. The set of operations may be provided as a set of executable instructions. Thus, the processing circuitry 410 is thereby arranged to execute methods as disclosed herein e.g. with reference to FIGS. 2B and/or 2C.

The storage medium 430 may also include persistent storage, which, for example, can be any single or combination of magnetic memory, optical memory, solid state memory or even remotely mounted memory.

The P node entity 400 may further include a communications interface 420 for communications with other entities, functions, nodes, and devices of the communication network. For example, the communications interface 420 may allow the P node entity 400 to communicate with e.g. a PE node entity and/or another P node entity. As such, the communication interface 420 may include one or more transmitters and receivers, including analogue and/or digital components.

The processing circuitry 410 controls the general operation of the P node entity 400 e.g. by sending data and control signals to the communications interface 420 and the storage medium 430, by receiving data and reports from the communications interface 420, and by retrieving data and instructions from the storage medium 430. Other components, as well as their related functionality, of the P node entity 400 are omitted in order not to obscure the concepts presented herein.

FIG. 4B schematically illustrates, in terms of functional modules 410a and 410b, the components of a P node entity 400 according to one embodiment of the present disclosure. The P node entity 400 includes at least an agree module 410a configured to perform step S205 of the method 200 described with reference to FIG. 2B, and an agree module 410b configured to perform step S207.

In general terms, each functional module 410a-c may be implemented in hardware or in software. Preferably, one or more or all functional modules 410a-c may be implemented by the processing circuitry 410, possibly in cooperation with the communications interface 420 and/or the storage medium 430. The processing circuitry 410 may thus be arranged to from the storage medium 430 fetch instructions as provided by a functional module 410a-c, and to execute these instructions and thereby perform any steps of the P node entity 400 as disclosed herein.

In some embodiments, the P node entity 400 may further include additional functional modules (not shown) required to perform also one or both of S206 and S208 of the method 200, and/or one, some or all of the steps S214-S216 of the method 201 described herein with reference to FIG. 2C. Such additional functional modules may e.g. include an allocate and associate module for performing step S206, an agree module for performing step S208, a MACsec processing module for performing step S214, an identify module for performing step S215, and an apply and send module for performing step S216. The P node entity 400 may also include e.g. a receive module for receiving the modified packet 271 from an adjacent PE node (or P node) entity. The P node entity 400 may also include e.g. a receive module for receiving the modified packet 270 from an adjacent PE node entity, or e.g. for receiving a packet 271 from an adjacent P node entity.

Various computer program products according to the present disclosure will now be described in more detail with reference to FIG. 5.

FIG. 5 schematically illustrates a computer program product 510a, 510b including computer readable means 530. On the computer readable means 530, a computer program 520a can be stored, which computer program 520a can cause the processing circuitry 310 and thereto operatively coupled entities and devices, such as the communication interface 320 and the storage medium 330, to execute steps S201-S204 of method 200 (and/or steps S210-S213 of method 201) according to embodiments described herein with reference to FIG. 2B (and/or FIG. 2C). The computer program 520a and/or computer program product 510a may thus provide means for performing any steps of the PE node entity as herein disclosed. On the computer readable means 530, a computer program 520b can also be stored, either in addition to or instead of the computer program 520a, which computer program 520b can cause the processing circuitry 410 and thereto operatively coupled entities and devices, such as the communication interface 420 and the storage medium 430, to execute steps S205-s207 of the method 200 (and/or steps S214-S216 of method 201) according to embodiments described herein with reference to FIG. 2B (and/or FIG. 2C). The computer program 520b and/or computer program product 510b may thus provide means for performing any steps of the P node entity as herein disclosed.

In the example of FIG. 5, the computer program product 510a, 510b is illustrated as an optical disc, such as a CD (compact disc) or a DVD (digital versatile disc) or a Blu-Ray disc. The computer program product 510a, 510b could also be embodied as a memory, such as a random-access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 520a, 520b is here schematically shown as a track on the depicted optical disk, the computer program 520a, 520b can be stored in any way which is suitable for the computer program product 510a, 510b.

The present disclosure also provides an improved label-switched network. Such a network corresponds e.g. to the network 100 illustrated in FIG. 1A, but with e.g. at least the PE node 120a replaced by a PE node entity as described herein (e.g. the PE node entity 300), and with at least one of the P nodes 130a-c replaced with a P node entity as described herein (e.g. the P node entity 400). Such a network is thus envisaged as being able to perform the various steps shown in e.g. FIG. 2B and/or FIG. 2C.

Although features and elements may be described above in particular combinations, each feature or element may be used alone without the other features and elements or in various combinations with or without other features and elements. Additionally, variations to the disclosed embodiments may be understood and effected by the skilled person in practicing the claimed invention as defined by the appended patent claims, from a study of the drawings, the disclosure, and the appended claims themselves. In the claims, the words “comprising” and “including” does not exclude other elements, and the indefinite article “a” or “an” does not exclude a plurality. The mere fact that certain features are recited in mutually different dependent claims does not indicate that a combination of these features cannot be used to advantage.

1. A method performed in a provider edge, PE, node of a label-switched network, comprising:
agreeing on a set of Media Access Control security, MACsec, policies with an adjacent provider (P) node of the network;
agreeing on an association between MACsec labels and MACsec policies with the adjacent P node, and
obtaining a set of user information rules, each user information rule being associated with a MACsec policy.

2. The method according to claim 1, further comprising:
receiving a user packet from a customer edge, CE, device;
extracting user side information from the user packet, and matching the user side information against the set of user information rules to identify a particular MACsec policy using the association between user information rules and MACsec policies;
identifying a particular MACsec label associated with the particular MACsec policy using the association between MACsec labels and MACsec policies agreed on with the adjacent P node;
modifying the user packet by inserting the particular MACsec label into the user packet, and
applying the particular MACsec policy to the modified user packet and sending the modified user packet to the adjacent P node.

3. The method according to claim 2, wherein modifying the user packet further comprises inserting, into the user packet, also a MACsec label identifier, MLI, identifying the particular MACsec label.

4. A method performed in a provider, P, node of a label-switched network, comprising:
agreeing on a set of Media Access Control security, MACsec, policies with an adjacent P node or provider edge (PE) node of the network;
agreeing on an association between MACsec labels and MACsec policies with the adjacent P node or PE node, and
agreeing on a set of MACsec policies with another adjacent P node or PE node of the network, and agreeing on an association between MACsec labels and MACsec policies with said another adjacent P node or PE node.

5. The method according to claim 4, further comprising:
receiving and processing a packet from the adjacent P node or PE node, the packet including a particular MACsec label;
identifying a particular MACsec policy associated with the particular MACsec label using the association between MACsec labels and MACsec policies agreed on with the adjacent P node or PE node, and
identifying a second particular MACsec label associated with the particular MACsec policy using the association between MACsec labels and MACsec policies agreed on with said another adjacent P node or PE node, inserting the second particular MACsec label into the packet, applying the particular MACsec policy to the packet and sending the packet to said another adjacent P node or PE node.

6. The method according to claim 5, wherein the packet further includes a MACsec label identifier, MLI, identifying the particular MACsec label, and the method further comprises identifying the particular MACsec label in the processed packet using the MLI.

7. A method performed in a label-switched network including a set of interconnected nodes, the set of interconnected nodes including at least a first provider edge, PE, node, a second PE node, and at least one provider, P, node provided in between the first and second PE nodes, the method comprising:
agreeing on a set of Media Access Control security, MACsec, policies for each interconnected node pair;
agreeing on an association between MACsec policies and MACsec labels for each interconnected node pair, and
establishing a set of user information rules and associating each user information rule with a MACsec policy in at least one of the first and second PE nodes.

8. The method according to claim 7, further comprising:
in one of the first and second PE nodes:
receiving a user packet from a first customer edge, CE, device adjacent to said one of the first and second PE nodes;
extracting user side information from the user packet, and matching the user side information against the set of user information rules to identify a particular MACsec policy using the association between user information rules and MACsec policies;
identifying a particular MACsec label associated with the particular MACsec policy using the association between MACsec labels and MACsec policies agreed on with the at least one P node;
modifying the user packet by inserting the particular MACsec label into the user packet, and
applying the particular MACsec policy to the modified user packet and sending the modified user packet to the at least one P node.
in the at least one P node:
receiving and processing the packet from said one of the first and second PE nodes;
identifying the particular MACsec policy associated with the particular MACsec label using the association between MACsec labels and MACsec policies agreed on with said one of the first and second PE nodes, and
identifying a second particular MACsec label associated with the particular MACsec policy using the association between MACsec labels and MACsec policies agreed on with another P node of the network or said other one of the first and second PE nodes, inserting the second particular MACsec label into the packet, applying the particular MACsec policy to the packet and sending the packet to said another P node or to said other one of the first and second PE nodes, and
in said other one of the first and second PE nodes:
receiving and processing the packet from the at least one P node or from another P node of the label-switched network, and
sending the packet to a second CE device adjacent to said other one of the first and second PE nodes.

9. The method according to claim 7, the label-switched network implementing Multi-Protocol Label Switching, MPLS.

10. The method according to claim 7, used to establish an end-to-end MACsec path between the first and second CE devices in a Level 3 virtual private network, L3VPN.

11.-15. (canceled)

16. A label-switched network, comprising a plurality of interconnected nodes, the plurality of interconnected nodes comprising:
a first provider edge, PE, node entity;
a second provide edge, PE, node entity, and
at least one provider, P, node entity,
wherein the network is configured to:
agree on a set of Media Access Control security, MACsec, policies for each interconnected node pair;
agree on an association between MACsec policies and MACsec labels for each interconnected node pair, and
establish a set of user information rules and associate each user information rule with a MACsec policy in at least one of the first and second PE nodes.

17. The network according to claim 16, wherein:
in one of the first and second PE nodes operate to:
receive a user packet from a first customer edge, CE, device adjacent to said one of the first and second PE nodes;
extracting user side information from the user packet, and matching the user side information against the set of user information rules to identify a particular MACsec policy using the association between user information rules and MACsec policies;
identifying a particular MACsec label associated with the particular MACsec policy using the association between MACsec labels and MACsec policies agreed on with the at least one P node;
modifying the user packet by inserting the particular MACsec label into the user packet, and
apply the particular MACsec policy to the modified user packet and send the modified user packet to the at least one P node.

18.-23. (canceled)
